(19) United States
(12) Patent Application Publication
(10) Pub. No.: US 2009/0172778 A1
(43) Pub. Date: Jul. 2, 2009

(54) Rule-based security system and method

(76) Inventor: Randall Stephens, Loma Linda, CA (US)

Correspondence Address: DEAN A. CRAINE, 9-Lake Bellevue Drive, Suite 208, BELLEVUE, WA, 98005, US

(21) Appl. No.: 12/005,646

(22) Filed: Dec. 26, 2007

(51) Int. Cl. G06F 21/22

(52) U.S. Cl. 726/2

(57) ABSTRACT

A rule-based security system and method that uses an environmental access control software program (EAC) loaded into the working memory of an electronic device to prevent unauthorized usage of selected hardware components, the operating software program or data files stored on the electronic device. The EAC includes a filter driver, a rules database, an environmental detection engine, a rules application engine, key generator, and a rules menu interface generator. During setup, the rules menu interface generator creates a menu that allows the administrator to select one or more environmental rules that are linked or coupled to various environmental factors on or connected to the electronic device. Some or all of these factors are assigned to a key share value. When accessed to a protected resource is requested, the environmental rule for the resource is determined and the key shares values associated with the resources recite in the environmental rule are combined to create a master access key or a temporarily access key that is compared to a stored master access key so that access to the resource is provided.

This is a utility patent application which claims benefit of U.S. Provisional Application No. 60/876,638 filed on Dec. 22, 2006.

### BACKGROUND OF THE INVENTION

1. Field of the Invention

This invention relates to security and anti-theft systems and methods used with electronic devices, and more particularly, to such systems and methods that control usage or access to files on a computer or similar electronic device that contains confidential data files.

2. Description of the Related Art

Various security systems and methods have been developed to prevent unauthorized use of a computer or to control access to software programs or specific data files on the computer. One type of security system and method uses encryption software that creates access codes that are stored locally in the computer's memory or in a file storage device connected to the computer. The software must be authenticated each time the computer is used or to access to a program or a data file requested. On another type of security system uses passwords or finger prints created by the user that are stored in the computer's memory that must be manually inputted into the computer and then authenticated by the operating system in order to operate the computer or to access a software program or specific data files stored thereon.

One drawback with security systems that use access codes, passwords or finger prints is that debugger programs can be used by hackers to circumvent them.

Another drawback with security systems that use access codes, passwords or finger prints is that they do not preclude thieves from stealing the computer, removing the file storage device from the computer, and then using a decoding software program to determine the access codes, passwords or finger print files stored on the computer.

Another drawback with current encryption and protection strategies that use simple local authentication rules on local computers is that they are not well suited for network environments. In a network environment, computers are often moved to different physical locations. The security system used in a network environment must have sufficient flexibility and management control so that as the location of a computer changes, the security for the computer is maintained.

Although data encryption techniques are known and prior art, what is non-obvious and novel is an anti-theft method that can actively lock and unlock data files and access to the operating system by detecting rule sets derived directly from the electronic device's detected environment. In addition, what is non-obvious and novel is the method of providing protection and access to the system by use of a authentication key(s), that is not stored on the local hard drive or in internal memory, but is created by using a combination of keys from various environment resources and conditions.

What is needed is an improved security system that does not use static access codes, passwords or finger print files stored on the local computer or in memory but uses dynamic access codes or keys created by the existing environmental resources or conditions.

### SUMMARY OF THE INVENTION

It is an object of the present invention to provide a security system and method that uses one or more environmental rules selectively created by the administrator or by the system itself which are then assigned a key share that when combined with other key shares, creates a unique master access key that can then be used to access or use a protected resource located on the electronic device or on a remote electronic device.

It is another object of the present invention to provide a security system that examines current environmental conditions when a user attempts to use the protected resource and the reconstructs the master access key to access the protected resource.

These and other objects of the invention are met by the rule-based security system disclosed herein that uses an environment access control software program, hereinafter known as EAC, that is loaded into the electronic device's working memory. The EAC includes a filter driver, a rules database, an environmental detection engine, a rules application engine, key generator, and a rules menu interface generator.

Stored in the rules database is a plurality of rules each associated with a particular local or network-based resource intended to be protected or have limited access. When access to the resource is requested, the filter driver intercepts the request and transmits it to the rules application engine to determine if the desired resource is associated with a particular environmental rule in the rule database. The rules application engine then contacts the environmental detection engine which determines if the environmental rule associated with the resource is satisfied. If the environmental detection engine determines that the environmental rule is satisfied, then the rules application engine retrieves the key share value assigned to the resource. A key generator then collects all of the key shares to create a master access key which can be used to access the resource. If the key share values do not create the master access key, then access is denied.

Each electronic device includes various hardware components, software execution programs, data files, drivers, memory configuration information, network information, and location information. The electronic device may also be directly or wirelessly connected to other hardware components. Also, when an authorized user logs onto the electronic device, the user's name and passage may also be provided. All of these elements are hereinafter referred to as environmental factors associated with the electronic device. During setup, some or all of the environmental factors are assigned a key share value.

Stored in the rules database is a plurality of environmental rules each associated with a particular local or network-based resource intended to be protected or have limited access. A resource may be any hardware component connected or coupled to the electronic device or a software program located onto the device or on a server or peripheral device connected to the electronic device. The resource may also be a data file stored on the electronic device or stored on a server or peripheral device connected to the electronic device.

During setup, a particular resource is designated as a protected resource and assigned a master access key. Each master access key is made up of one or more key share values. When access to the protected resource is requested, the filter driver intercepts the request and transmits it to the rules application engine to determine if the desired resource is associated with a particular environmental rule in the rule database. The rules application engine then contacts the environmental detection engine which determines if the environmental rule associated with the resource is satisfied. The environmental rule may pertain to one or more of the factors located on or associated with the local electronic device, on a remote electronic device, or to the user's name and password. If the environmental detection engine determines that the environmental rule is satisfied, then the rules application engine retrieves the key share value assigned to each factor specified in the rule. The key generator then collects all of the key shares to create a master access key to access the protected resource. If the combined key shares do not create the master access key, then access to the protected resource is denied.

When setting up the system, master access key rules are created that determine what key share value must be combined and used to create the master access key for the protected resource. The generated master access key may be used or the system may include a comparison step in which the combined key share values produce a temporary master access key that is then compared to a master access key stored locally in the rule database or on a server. Alternatively, the master access key could be embedded or encrypted into the files or into the drivers used to control the protected resource.

During setup, the rules menu generator is used to create a single environment rule or a set of environmental rules associated with all or some resources. The assignment of a rule or set of rules and the nature of the rule can be changed dynamically by the administrator at any time. As stated above, an environmental factor may be various hardware components, different software programs, data files, the memory configuration, or the network address for the electronic device for a remotely connected device, such as a networked connected server. An environmental factor may also be a peripheral device connected to the electronic device. The environmental factor may also be the user's personal information, his or her password, a telephone number, a street address and zip code, which must be stored or loaded into the electronic device's memory prior to usage. The EAC may also include an optional monitoring module that enables the system to query the resources on the electronic device for updates so that the most current key shares are recorded.

The above described system is described as being used with an electronic device. The electronic device may be a single computer, a cellular telephone, or DDA in a computer network environment. If used in a network environment, the network administrator remotely selects an environmental rule or set of environmental rules for each client machine and then stores them into the client machine or on the server. When the user tries to use the client computer, a temporary access key for the client computer may be generated and authenticated by comparing it with the master access key for the client computer on the client computer or in a client rules database on the server. If the temporary and master access keys do not match, operation of the client computer is provoked and/or access to the network is denied.

### DESCRIPTION OF THE DRAWINGS

FIG. 1 is an illustration of a computer connected to various hardware components and software components, with the EAC software program loaded therein with the rules menu shown on the computer's display.

FIG. 2 is a diagram showing a protected resource with a master access key assigned thereto created by key share valves assigned to different environmental factors.

FIG. 3 is a flow diagram showing access to a non-protected resource using the EAC system.

FIG. 4 is a flow diagram showing access to a protected resource using the EAC system.

FIG. 5 is a table showing the various environmental factors associated with the computer being assigned an environmental rule and a key value.

FIG. 6 is an illustration showing the EAC software program assigning a key share value to three environmental rules and then collecting the key share values to create a master access key.

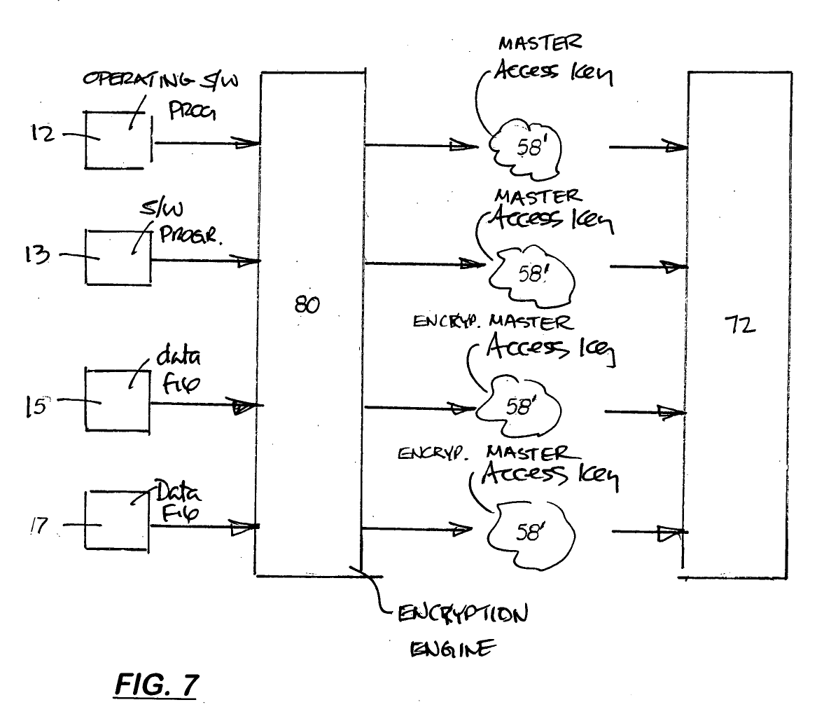

FIG. 7 is an illustration showing four environmental factors, the operating software program, an executable software program, an internally stored data file and an externally stored data file being encrypted and then stored in the rules application engine.

FIG. 8 is a flow chart illustration of the entire rule-based security system disclosed herein showing a network configuration.

FIG. 9 is a block flowing diagram depicting the steps in the method of securing files on a computer using the system.

### DESCRIPTION OF THE PREFERRED EMBODIMENT(S)

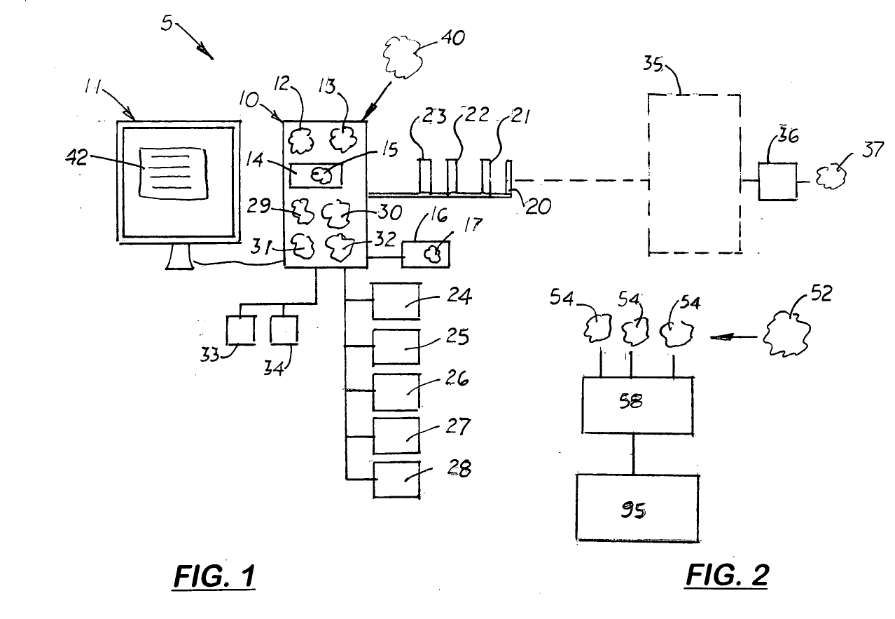

Referring to the Figs there is shown an anti-theft system 5 comprised of an EAC 40 loaded into the working memory of an electronic device, hereinafter represented as a computer 10. Also loaded into the working memory of the computer 10 is a software operating program 12 and various executable software programs 13. The computer 10 may include internal or external file storage devices 14, 16 with data files 15, 17, respectively, stored thereon. The stored thereon. The computer 10 may also include various hardware components, such wired or wireless controller cards 20, 21, sound card 22, video card 23, scanner 24 or fingerprint reader 25, iris scanning device 26, a wireless network device 27, or peripheral devices 28. The computer 10 may also include drivers 29, memory configuration information 30, network information 31, and physical location information 32, as well as authorized user names 33 and passwords 34. In FIG. 1, the computer 10 may be connected to a wired or wireless network 35 with remote computers 36 containing data files 37. As described herein, all of these items 12-37 associated or connected to the computer 10 are generally referred to as ‘environmental factors’. Some or all of these environmental factors may need protection and are restricted to authorized users. Those environmental factors that are protected are called ‘protected resources’, and are denoted generally by reference number 95.

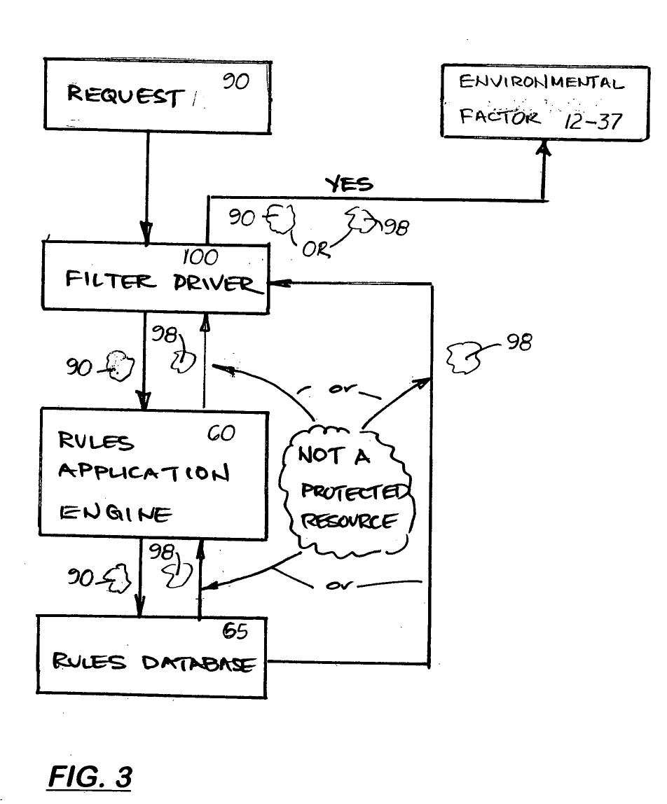

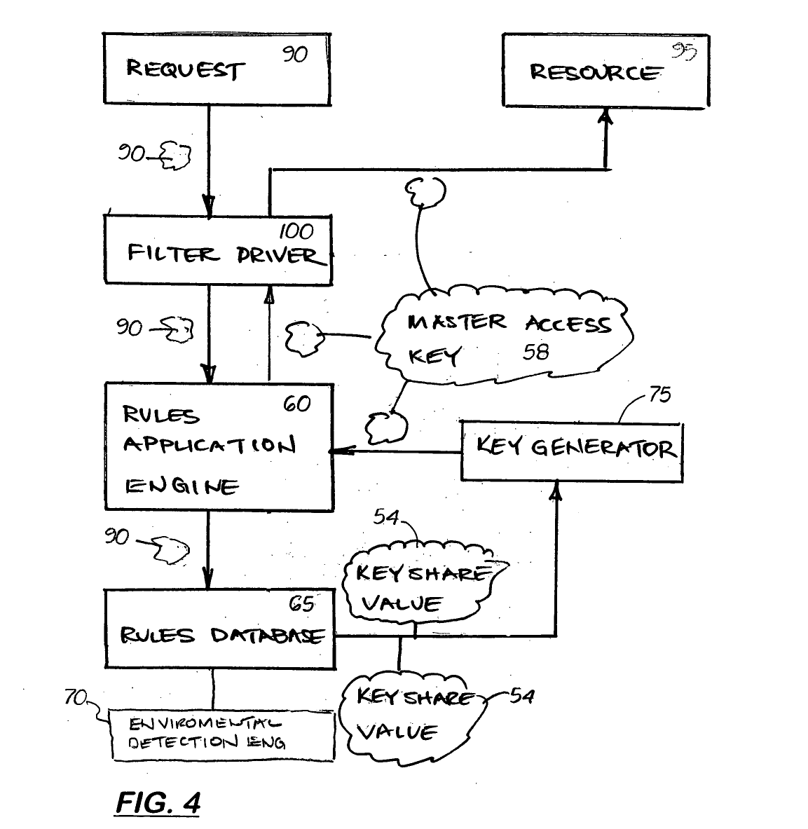

During setup, a particular protected resource 95 is assigned a master access key 58. Each master access key 58 is made up of one or more key share values 54 as shown in FIG. 2. As shown in FIG. 3, when a request 90 is made to use or access one of the environmental factors 12-37, a filter driver 100 created by the EAC program 40 intercepts the request 90 and transmits it to a rules application engine 60 also created by the EAC program 40. The rules application engine 60 then contacts a rules database 55 to determine if the factor 12-37 is a protected resource 95. If the factor 12-37 is not a protected resource 95, the original request signal 90 or new signal 98 is sent from the rules application engine 60 which then transmits the original request 90 or new signal 98 to the desired environmental factor 12-37.

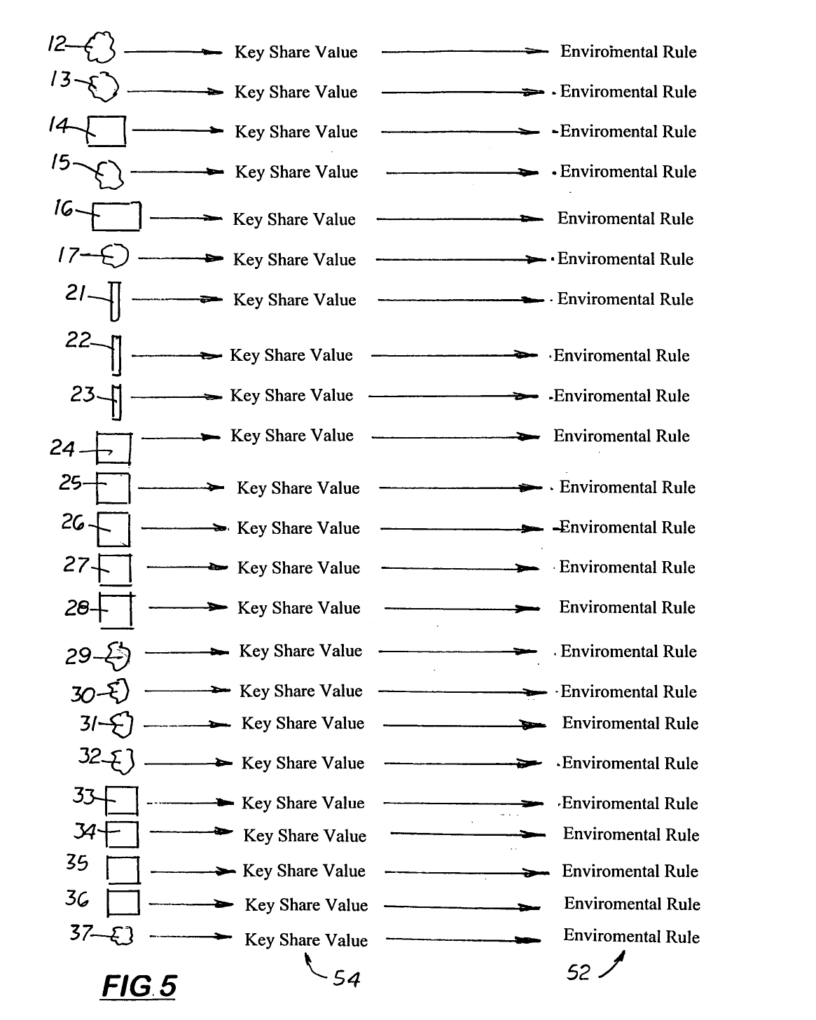

As shown in FIG. 4, if the factor 12-37 is a protected resource 95, then the rules database 55 contacts a environmental detection engine 70 which then determines if the environmental rule 52 associated with the protected resource 95 is satisfied. If the environmental detection engine 70 determines that the environmental rule 52 is satisfied, then the rule share values 54 assigned to the environmental factor 12-37 identified in the environment rule 52 are retrieved and delivered to a key generator 75 then collects the key share values 54 to create a master access key 58. The request 90 is then delivered to the protected resource 95. If the combined key share values 54 do not create the master access key 58, then the request 90 is not delivered to the protected resource 95 and access to the protected resource 95 is denied

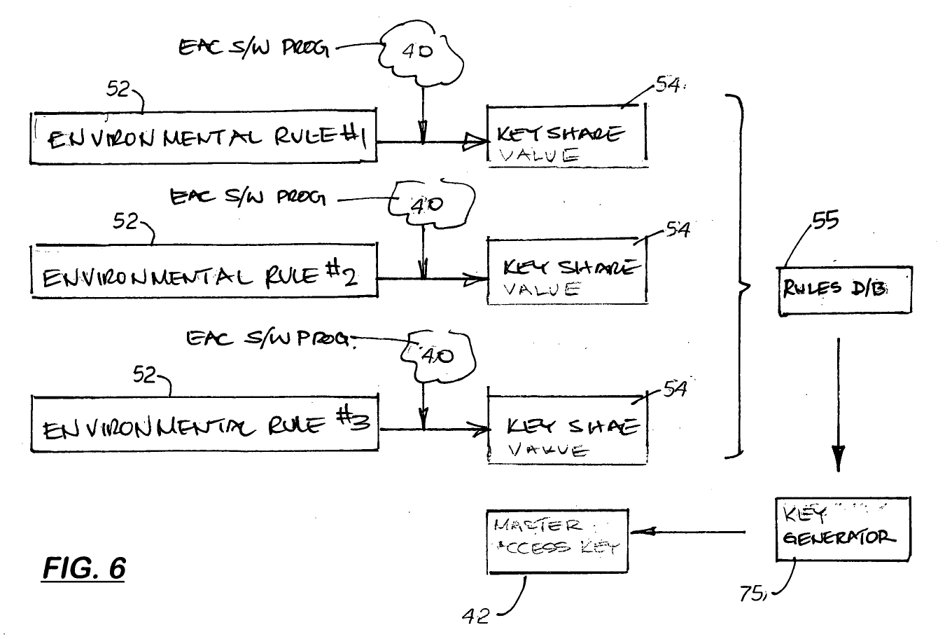

The EAC 40 is loaded into the computer's memory or loaded into the working memory of a remote computer 36 connected to the computer 10 via a wired or wireless card 20, 21 and network 35. During setup, the EAC 40 creates a rules menu 42 presented on a display 11. Also during setup, some or all of the various environmental factors 12-37 are assigned a key share value 54 as shown in FIG. 5. Those environmental factors 12-37 that the administrator wants to regard as a protected resource 95 are also assigned an environmental rule 52.

The nature of the key share value 54 assigned to a particular environmental factor 12-37 is dependent on the nature of the environmental factor 12-37. For example, if the environmental factor is a particular hardware component 14, 21-28 on the computer 10, then the key share value 54 may be a unique identify indicia for the hardware component, such as a MAC number, its memory size, its speed value, etc. If the environmental factor is a particular software program 12, 13 or data file 15, 17, then the nature of the environmental factor may pertain to a unique file name, size or some other unique program or file identifier.

If the environmental factor is the electronic device's memory configuration 30, network address 31, physical address 32, the user's name 33, password 34 or remote computer computer identification 36, they may be entered manually or automatically detected by the EAC 40. During the setup process, the environmental factors and assigned as a unique key share value, then designated a protected resource and recorded in the rules menu 42.

After a key share value 54 have been assigned to all or some of the environmental factors 12-37, each protected resource 95 must be selected and associated with an environmental rule 52. Each environmental rule 52 consists of the key share value or values of one or more environmental factors 12-37 associated with the computer 10. Unless access is requested, the pressure of the environmental factor must be detected or verified when access or use of the protected resource is requested. The nature of the environmental rule 52 depends on the types of environmental factors 12-37 associated with the computer 10 and the level of security needed. The environmental rule 52 may require the presence of one or more environmental factors 12-37. In most instances, the greater number of environmental factors 12-37 are required in the environmental rule 52, the greater the security.

Once all of the desired protected resources 95 have been determined, a unique environmental rule 52 for each protected resource 95 has been created, and a key share value 54 has been assigned to the environmental factor 12-37 set forth in the environmental rule 52, the key shares values 54 for each environmental rule 52 are then delivered to the rules database 55. When an access request is made, the rules database 55 delivers all of the key shares values 54 for the environmental factor required for the rule to the key generator 75 which then uses the key shares values 54 to create a master access key 58.

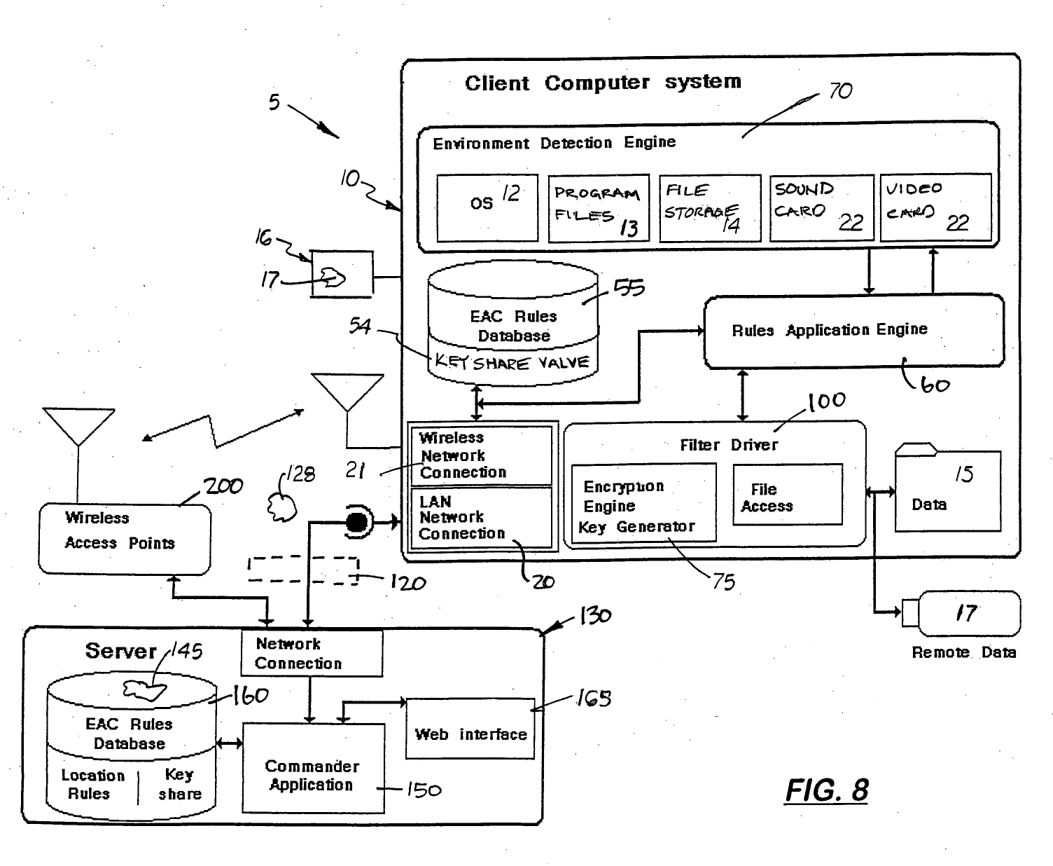

After the master access key 58 has been generated, it may be sent to an encryption engine 80 for encryption, as shown in FIG. 7. In both instances, the master access key 58 or encrypted master access key 58′ may be saved with file on the computer, stored with the driver driver of the protected resource or stored in a separate storage device (generally indicated by the reference number 72).

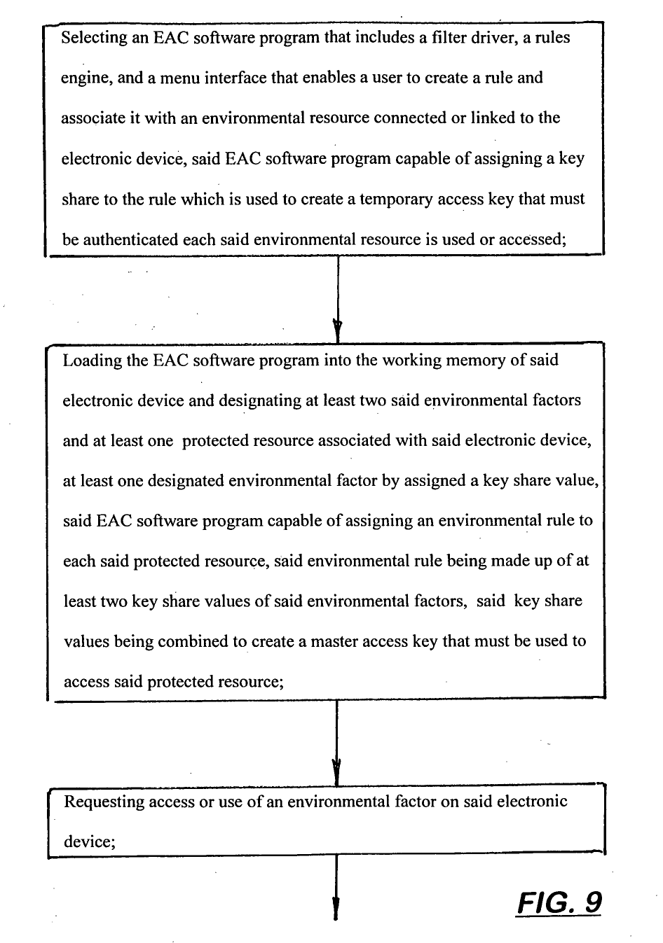

As shown in FIG. 8, in another embodiment, the system 5 may be used in a network environment where the network administrator remotely selects a rule or set of rules for each client machine connected to the network 120 and then stores them into a client rules database 160 on the server 130. When the user tries to use the client computer 10 and connect to the network 120, an access key 128 for the client computer 10 is generated and authenticated by comparing it with an access key 145 in the client rules database 160. If the access key 128 can not be authenticated, operation of the client computer 10 is provoked and/or access to the network 120 is denied.

To allow easy setup of the rules on mobile client electronic devices 10, remote configuration is also obtainable through the server 130. Communication to the client computer 10 can be achieved be mean of wireless access point(s) 200 or over the LAN network connection 20 depending on the user's network capabilities.

Residing on the server 130 is an optional commander software application 150, a web interface 160, and an EAC rules database 160.

In the case of additional protection, the user may decide to store the EAC rules on the server 130 verse the client's local database shown in FIG. 1. During the rules application process, the EAC rule(s) 52 and key share value(s) 54 will then be stored or retrieved from the server's EAC rules database 160 through either a wired or wireless RF 230 or LAN network connection 20, 21, respectively. The commander software application 150 will also provide a mean to provide user input via a Web interface 165. This will allow user's to view, track and change their client computer 10 configuration from any remote network location.

An important aspect of the system 5 is the use of the filter driver 100 that allows real time access control at the level of the operating system, directly above the file system itself. By using a filter driver 100 and an EAC rule checking feature at this position most common invasive attacks are thwarted. This approach is very different from the current state of the art in device driver design, which mandates that drivers should be single purpose and dedicated to a sole function, e.g. encryption/decryption only.

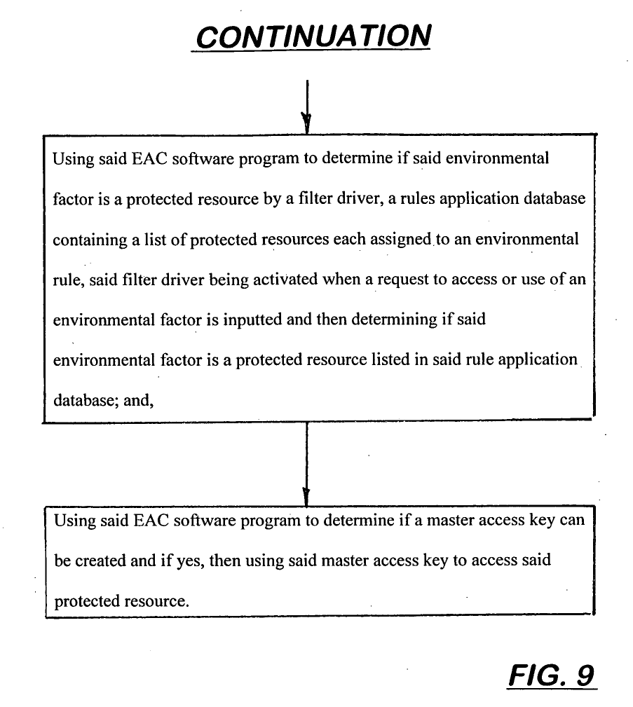

FIG. 9 shows the EAC Rules control flow diagram. The EAC Rules Engine is also unique as it provides both the basis for real time access control and updates, and allows an authorized user or administrator to change the active rule set dynamically. In addition, the Rules Engine can automatically change active rule sets based on predefined criteria, i.e. network access, user name, etc. The Rules Engine can update the current rule set in two ways; the first is via an update that is posted by an administrator, and the second is when any of the systems environmental variables are changed. As shown in the diagram, the Rules Engine Monitoring Module is querying for updates from all registered environmental components, such as network access, location, user name, and any other criteria specified by the administrator. The Monitoring Module is designed using an abstract component model to allow interfacing with a wide variety of environmental variables, both hardware and software. This model also provides the ability to add new environmental variables at any time without software changes. The Rules Engine stores the current rule set in memory and also encrypts it to prevent access by any memory analysis tools. This ability to dynamically change the access control at the directory or even file level is unique and novel to the system, as is the ability to monitor any machine environment variable and add new variables dynamically.

An important aspect of the system is that the key generation mechanism for encrypting encrypting files is dynamically created and determined by the changeable active rule set. Each active rule is represented by a 32 bit unique identifier, which is the access key for that rule. To generate an encryption key, the rules engine 60 takes the key share value 54 for each active rule 52 and combines them together, the result is used as the seed for a random number generator that assigns a 256-bit key. The number of rules 52 does not affect the randomness of the generated encryption key. This feature allows the master access keys 58 to be generated in a repeatable fashion but without predictability thereby opening a window to attack.

In compliance with the statute, the invention described herein has been described in language more or less specific as to structural features. It should be understood however, that the invention is not limited to the specific features shown, since the means and construction shown, is comprised only of the preferred embodiments for putting the invention into effect. The invention is therefore claimed in any of its forms or modifications within the legitimate and valid scope of the amended claims, appropriately interpreted in accordance with the doctrine of equivalents.

I claim:

1. A rule-based security system, comprising:
a. an electronic device with working memory and at least one environmental resource connected or linked thereto; and,
b. an environmental access control program loaded in to said working memory of said electronic device, said environmental access control program provides a visual menu with at least one environmental rule created thereon that is selected by an authorized user, said environmental rule being associated with at least one protected resource connected or linked to said electronic device, said protected resource being assigned to a main access key, said environmental access control program also assigns a key share value to a plurality of designated environmental factors on or connected to said electronic device, when a request for a protected resource is made on said electronic device, said environmental access control program determines if said environmental rule is satisfied and then creates said main access key so that protected resource may be accessed or used.

2. The rule-based security system, as recited in claim 1, wherein said electronic device is a computer.

3. The rule-based security system, as recited in claim 1, wherein said environmental factors may include one of the following: a hardware component connected or coupled to said electronic device, or a software execution program or data file stored on said electronic device.

4. The rule-based security system, as recited in claim 3, wherein said electronic device is a computer.

5. The rule-based security system, as recited in claim 1, wherein said protected resource is an environmental factor from the following group: a software program or data file stored on said electronic device, a software program or data file stored on a peripheral device and connected to said electronic device, or a remote device connected via a wired or wireless computer to said electronic device.

6. The rule-based security system, as recited in claim 2, wherein said protected resource is an environmental factor from the following group: a software program or data file stored on said electronic device, a software program or data file stored on a peripheral device and connected to said electronic device, or a remote device connected via a wired or wireless computer to said electronic device.

7. The rule-based security system, as recited in claim 3, wherein said protected resource is an environmental factor from the following group: a software program or data file stored on said electronic device, a software program or data file stored on a peripheral device and connected to said electronic device, or a remote device connected via a wired or wireless computer to said electronic device.

8. The rule-based security system, as recited in claim 4, wherein said protected resource is an environmental factor from the following group: a software program or data file stored on on said electronic device, a software program or data file stored on a peripheral device and connected to said electronic device, or a remote device connected via a wired or wireless computer to said electronic device.

9. The rule-based security system, as recited in claim 1, wherein said environmental factors may include one of the following: a software driver located on said electronic device, a peripheral device connected to said electronic device, a remote electronic device connected via a wired or wireless network.

10. The rule-based security system, as recited in claim 2, wherein said environmental factors may include one of the following: a software driver located on said electronic device, a peripheral device connected to said electronic device, a remote electronic device connected via a wired or wireless network

11. The rule-based security system, as recited in claim 5, wherein said environmental factors may include one of the following: a software driver located on said electronic device, a peripheral device connected to said electronic device, a remote electronic device connected via a wired or wireless network

12. The rule-based security system, as recited in claim 1, wherein said environmental factors may include one of the following: the user's name, the user's password, the physical location of the electronic device.

13. The rule-based security system, as recited in claim 2, wherein said environmental factors may include one of the following: the user's name, the user's password, the physical location of the electronic device.

14. The rule-based security system, as recited in claim 5, wherein said environmental factors may include one of the following: the user's name, the user's password, the physical location of the electronic device.

15. The rule-based security system, as recited in claim 6, wherein said environmental factors may include one of the following: the user's name, the user's password, the physical location of the electronic device.

16. The rule-based security system, as recited in claim 9, wherein said environmental factors may include one of the following: the user's name, the user's password, the physical location of the electronic device.

17. A method for controlling access to resources on an electronic device with working memory and various environmental factors connected or stored therein, said method comprising the following steps:
a. selecting an EAC software program that includes a filter driver, a rules engine, and a menu interface that enables a user to create a rule and associate it with an environmental resource connected or linked to the electronic device, said EAC software program capable of assigning a key share value to the rule which is used to create a temporary access key that must temporary access key that must be authenticated each said environmental resource is used or accessed;
b. loading the EAC software program into the working memory of said electronic device and designating at least one said environmental factor and at least one protected resource associated with said electronic device, at least one designated environmental factor by assigned a key share value, said EAC software program capable of assigning an environmental rule to each said protected resource, said environmental rule being made up of at least one key share value of said environmental factor, said key share value being combined to create a master access key that must be used to access said protected resource;
c. requesting access or use of an environmental factor on said electronic device;
d. using said EAC software program to determine if said environmental factor is a protected resource; and,
e. using said EAC software program to determine if a master access key can be created and if yes, then using said master access key to access said protected resource.

18. The method as recited in claim 17, wherein step (e) of determining if said environmental factor is a protected resource is performed by a filter driver, a rules application database containing a list of protected resources each assigned to an environmental rule, said filter driver being activated when a request to access or use of an environmental factor is inputted and then determining if said environmental factor is a protected resource listed in said rule application database.
